(19) United States
(12) Patent Application Publication
(10) Pub. No.: US 2021/0347000 A1
(43) Pub. Date: Nov. 11, 2021

(54) Tool Holder Suitable for Hybrid Cryogenic Minimum Quantity Lubrication

(71) Applicant: DALIAN UNIVERSITY OF TECHNOLOGY, Dalian, Liaoning (CN)

(72) Inventors: Yongqing WANG, Dalian, Liaoning (CN); Ziyou BAN, Dalian, Liaoning (CN); Kuo LIU, Dalian, Liaoning (CN); Lingsheng HAN, Dalian, Liaoning (CN); Fanze KONG, Dalian, Liaoning (CN); Siqi WANG, Dalian, Liaoning (CN)

(21) Appl. No.: 16/972,278

(22) PCT Filed: Feb. 28, 2020
(86) PCT No.: PCT/CN2020/077114

§ 371 Date: Dec. 4, 2020

(30) Foreign Application Priority Data
Dec. 2, 2019 (CN) 201911212074.0

(51) Int. Cl. B23Q 11/10; B23Q 3/12

(52) U.S. Cl. CPC B23Q 11/1046; B23Q 3/12

(57) ABSTRACT

The invention provides a tool holder suitable for cryogenic minimum quantity lubrication, which belongs to the technical field of cooling and lubrication of numerical control machine tools. The device comprises a toolholder body, a peripheral static structure, a multilayer sealing structure, a heat insulation structure, and a bearing support structure. The invention solves the problems of insufficient cooling performance in the micro-lubrication technology and insufficient lubrication in the cryogenic cooling machining technology, and integrates the oxygen insulation protection effect of the cryogenic medium, the cooling effect of the cryogenic medium, and the friction reduction and lubrication effect of the micro-lubrication. It has a good processing effect on difficult-to-cut materials. The invention can be used for machining difficult-to-cut materials with traditional numerical control machine tools, expands the application range of external to internal cooling tool holders, effectively reduces the cutting heat of difficult-to-cut materials in cutting processing, improves tool life, and replaces traditional cutting fluids to achieve green manufacturing.

The present invention belongs to the technical field of cooling and lubrication of numerically controlled machine tools, and particularly relates to a tool holder suitable for hybrid cryogenic minimum quantity lubrication.

### BACKGROUND

At present, some difficult-to-cut materials such as titanium alloys and high-temperature alloys with excellent characteristics including high temperature resistance and corrosion resistance, have become the main materials used in the manufacture of parts in the high-end equipment fields such as aerospace. However, these difficult-to-cut materials usually exhibit characteristics such as high viscosity, high toughness, and anisotropy, which brings a series of problems to the cutting process: the temperature of the cutting zone is high, the tool life is short, and the surface quality of the parts is generally difficult to meet the target requirements. The latest domestic and foreign research shows that under the condition of given machine tools and cutting tools, simply optimizing cutting parameters will have limited improvement in the quality and efficiency of difficult-to-cut material parts. The use of a large amount of cutting fluid for cooling has serious environmental pollution. The use of cutting fluid will cause rapid cooling impact on the surface of the tool, causing problems such as chipping and microcracks, and accelerating tool damage. To this end, the researchers applied hybrid cryogenic minimum quantity lubrication technology referred as to CMQL to the cutting of difficult-to-cut materials.

CMQL is a cooling lubrication method that mixes and atomizes the cold air stream with a very small amount of pollution-free cutting fluid and sprays it to the cutting zone. Under the dual action of a small amount of cutting fluid and cold air flow, it can effectively reduce and control the temperature of the cutting zone, maintain the hardness of the tool and is not easy to generate built-up edge, so it has a good machining effect on difficult-to-cut materials and can reduce the surface roughness. Hence, it is a kind of advanced manufacturing technology suitable for cutting difficult-to-cut materials.

CMQL combines minimum quantity lubrication (MQL) and cryogenic cooling technology. Among them, the MQL, which is belong to near dry machining, is to use a certain pressure of compressed air and a small amount of cutting fluid to combine into oil mist, and then spray it to the cutting zone at high speed to play the role of lubrication and cooling, reduce tool wear, reduce cutting temperature, improve workpiece quality and machining efficiency. Cryogenic machining is a cutting method that reduces the cutting temperature by using cryogenic fluid as the cooling medium. Cryogenic machining can uniformly reduce the temperature of the workpiece and the tool, increase the low-temperature brittleness of the processed material, which are conducive to cutting and can reduce tool wear, increase tool life, improve the quality of the processed surface of the workpiece, and almost no pollution to the environment. Although the advantages of MQL technology and Cryogenic machining are significant, there are many limitations when working alone. The introduction of Cryogenic machining in MQL can effectively solve the problems of insufficient lubrication and insufficient cooling performance in conventional MQL. Experiments have shown that CMQL can effectively reduce the extremely high cutting heat of difficult-to-cut materials in the cutting process, improve material cutting performance, increase tool life, and replace traditional cutting fluids to achieve green manufacturing.

At present, there are two medium supply methods for MQL and cryogenic machining, namely, internal spraying and external spraying. The external spraying method can be realized by only the external medium supply and the spray device, and it has become the main method of cryogenic medium supply at present. However, the external spraying method has the disadvantages that the cooling and lubrication efficiency is not high, and the cutting zone cannot be accurately and efficiently cooled and lubricated. Therefore, the use of external to internal cooling tool holders in the CMQL can not only solve the problem of low cooling and lubrication efficiency, but also be suitable for traditional CNC machine tools for CMQL processing.

In 2012, as described in the patent “An external to internal cooling tool holder” (Application No.: CN201220515154.0) from Sun Xiaoming et al, the conventional cutting fluid is used as the internal cooling medium and flows into the rotating tool through the cutting fluid channel to realize the internal cooling of the tool. In 2019, as described in the patent “A tool holder suitable for cooling and lubricating by cryogenic coolant” (Application No.: CN201710111738.9) from Wang Yongqing et al, the tool holder is directly connected with the liquid nitrogen supply system to realize the internal spray type cryogenic machining. None of the above invention patents mentions a tool holder suitable for hybrid cryogenic minimum quantity lubrication.

### SUMMARY

The main technical problem solved by the present invention is that the existing external to internal cooling tool holder cannot be used in the CMQL cutting method, and overcome the shortcomings of the existing tool holder in the heat insulation and sealing performance at the same time. A tool holder suitable for hybrid cryogenic minimum quantity lubrication is proposed.

The technical solution of the present invention:

A tool holder suitable for hybrid cryogenic minimum quantity lubrication comprise a toolholder body 1, a peripheral static structure, a multilayer sealing structure, a thermal insulation structure and a bearing support structure.

The left end of toolholder body 1 is a tapered surface 1-d, which is used to connected with the machine tool spindle head 6.3 to position the tool holder. There is an internal thread 1-f of the tool holder which is perpendicular to the tapered surface 1-d at the end of tapered surface 1-d. The extension of the tapered surface 1-d is provided with a flange 1-g. The right end of the toolholder body 1 are stepped shafts, which are used for the positioning and installation between the toolholder body 1 and the others structures, from the left to the right, there are shoulder of the stepped shaft 1-h, toolholder external thread I 1-c and toolholder external thread II 1-o. Between the toolholder external thread I 1-c and the toolholder external thread II 1-o, there are ring groove I 1-i and ring groove II 1-m from left to right. The ring groove I 1-i is connected to internal flow channel II 1-b, the inlet of the internal flow channel II 1-b is connected to the ring groove I 1-i; the ring groove II 1-m is connected internal flow channel I 1-a, internal flow channel I 1-a is a circular hole flow channel with an inclined angle θ to the horizontal plane, the inlet of the internal flow channel I 1-a is connected to the ring groove II 1-m. Internal flow channel I 1-a is connected with internal flow channel III 1-p which is a horizontal circular channel located at the right end of the inside of the toolholder body 1. The fluid medium exiting from the internal flow channel III 1-p will enter hollow internal cooling cutting tool 6.7. There is a toolholder internal shoulder I 1-j, a toolholder internal shoulder II 1-k and a toolholder internal shoulder III 1-l in the toolholder body 1; of which the toolholder internal shoulder I 1-j is located at the junction of internal flow channel II 1-b and internal flow channel III 1-p, the toolholder internal shoulder II 1-k and the toolholder internal shoulder III 1-l are respectively located on both sides of the internal flow channel I 1-a, used for the positioning of toolholder body heat insulation sleeve 4.1 and channel separator sleeve 4.2 when they are installed in the toolholder body 1. The inside on the right side of the toolholder body 1 is the tool positioning tapered surface 1-n, which is used for the hollow internal cooling cutting tool 6.7 when installed and positioned through elastic collet 6.8 and the toolholder body 1.

The peripheral static structure comprises a metal shell 2.1, a heat-insulation shell 2.2 and an adapter sleeve 2.3. The metal shell 2.1, which is positioned by internal positioning shoulder 2.1-a of the metal shell 2.1 and bearing I 5.2, is installed on the outside of the internal bearing assembly. The heat-insulation shell 2.2 is made of materials with low thermal conductivity; the adapter sleeve 2.3 is made of materials with low thermal conductivity, and it is installed on the outside of the shaft of the toolholder body 1 where the ring groove I 1-i and ring groove II 1-m are located, adapter sleeve 2.3 is provided with internal threaded hole I 2.3-a and internal threaded hole II 2.3-d. The internal threaded hole I 2.3-a is used to connect with the insulated hose connector external thread 6.1-a of the external cryogenic medium L1 transportation system, and is the entrance of the cryogenic medium L1, internal threaded hole II 2.3-d, which is the inlet of the cutting fluid L2, is used to connect with the hose connector external thread 6.5-a of the external cutting fluid L2 transportation system. The solidification temperature of the cutting fluid L2 is low; the inner surface of the adapter sleeve 2.3 is provided with arc groove I 2.3-b and arc groove II 2.3-g, which are respectively connected with the ring groove I 1-i and the ring groove II 1-m of the toolholder body 1. The cryogenic medium L1 flows in through the internal threaded hole I 2.3-a, is temporarily stored and buffered in the arc groove II 2.3-g, and then flows into the internal flow channel I 1-a of the toolholder body 1; at the same time, a small amount of cutting fluid L2 flows in through the internal threaded hole II 2.3-d, and is temporarily stored and buffered in the arc groove I 2.3-b, and then flows into the internal flow channel II 1-b of the toolholder body 1. Cryogenic medium L1 and cutting fluid L2 form a mixed medium L in mixing zone 6.6 and enter the hollow internal cooling cutting tool 6.7, and finally spray to the cutting zone; the mixing zone 6.6 is located at the end of the toolholder body 1 where is the exit of the channel separation sleeve 4.2. There are peripheral sealing tooth I 2.3-c, peripheral sealing tooth II 2.3-e, peripheral sealing tooth III 2.3-f in the inner surface of the adapter sleeve 2.3 , they and the corresponding surface of the toolholder body 1 to form a sealing structure I 3.3-a, sealing structure II 3.3-b and sealing structure II 3.3-c respectively; the peripheral sealing tooth I 2.3-c is located on the left side of the arc groove I 2.3-b, and peripheral sealing teeth II 2.3-e is located between arc groove I 2.3-b and arc groove II 2.3-g, and peripheral sealing tooth III 2.3-f is located at right of the arc groove II 2.3-g.

The multilayer sealing structure comprises left gland of sealing ring 3.1, contact sealing ring I 3.2, sealing structure 3.3, contact sealing ring II 3.4, and right gland of sealing ring 3.5, inner seal ring 3.6 in the flow channel and end face seal 3.7; The labyrinth sealing structure 3.3 includes three seal structures, namely seal structure I 3.3-a, seal structure II 3.3-b and seal structure III 3.3-c; the peripheral sealing tooth I 2.3-c of the adapter sleeve 2.3 and the corresponding shaft surface of the toolholder body 1 are formed the seal structure I 3.3-a to increase the resistance of leakage flow and improve the sealing effect for the cutting fluid L2. The sealing structure II 3.3-b is composed of the peripheral sealing tooth two 2.3-e of the adapter sleeve 2.3 and the corresponding shaft surface of the toolholder body 1, which is used to increase the flow resistance and increase the sealing effect of cryogenic medium L 1 and cutting fluid L2 to prevent the premature mixing of the two media from affecting the effect of CMQL cutting; the sealing structure III 3.3-c comprises the peripheral sealing tooth III 2.3-f of the adapter sleeve 2.3 and corresponding shaft surface of the toolholder body 1, which is used to increase the flow resistance and improve the sealing effect to the cryogenic temperature medium L1. The end face seal 3.7 is located on the right side of the internal flow channel 1-a in the toolholder body 1, and is used to prevent leakage for the cryogenic medium L1 when the hollow internal cooling cutting tool 6.7 contact with the toolholder body 1; the left gland of sealing ring 3.1 and the right gland of sealing ring 3.5 are respectively distributed on both sides of the adapter sleeve 2.3, and are connected with the adapter sleeve 2.3 by bolts to compress the contact seal ring I 3.2 and contact seal ring II 3.4. The contact seal ring I 3.2 is made of materials with low thermal conductivity and high temperature resistance, which is used to prevent the cutting fluid L2 from leaking into the internal bearing system and ensure the normal operation of the bearing components; the contact seal ring II 3.4 is also made of materials with low thermal conductivity and high temperature resistance, it is used to prevent the cryogenic medium L1 from leaking into the outside surface of the tool holder causing frost on the surface and affecting the normal operation;

The thermal insulation structure comprises toolholder body heat insulation sleeve 4.1, channel separation sleeve 4.2, channel heat insulation sleeve 4.3, heat insulation filler 4.4 and heat insulation shell 2.2. The heat insulation structure is made of materials with low thermal conductivity; the heat insulation sleeve 4.1 of the toolholder body is located in front of the mixing zone 6.6 for reducing the thermal influence of the cryogenic medium L1 on the toolholder body 1; the channel separation sleeve 4.2 is located in the end of the internal flow channel II 1-b and is made of materials with low thermal conductivity to separate the internal flow channel I 1-a and the internal flow channel II 1-b, to ensure that the fluids do not interfere with each other before entering the mixing zone 6.6, and reduce the influence of the cryogenic medium L1 on the cutting fluid L2. The channel heat insulation sleeve 4.3 is wrapped on the outside of the internal flow channel I 1-a of the toolholder body 1 to reduce the low temperature is influence on the toolholder body when the cryogenic medium L1 flows through internal flow channel I 1-a; the heat insulation filler 4.4 is wrapped on the outside of the metal shell 2.1; the heat insulation shell 2.2 is installed on the outside of the thermal insulation filler 4.4, and the metal shell 2.1 is connected by bolts to compress heat insulation filler 4.4.

The bearing support structure comprises tightening nut 5.1, bearing I 5.2, bearing sleeve 5.3, bearing II 5.4 and bearing gland 5.5. The bearing II 5.4 is installed on the shoulder of stepped shaft 1-h of the toolholder body 1, inserting the bearing sleeve 5.3 and the bearing I 5.2 in sequence, and then locking the bearing by the tightening nut 5.1 which can generate pre-tightening force, and realizing the fixing of the bearing support structure on the outer surface of toolholder body 1; bearing I 5.2 and bearing II 5.4 are bears with contact seal rings.

The transportation insulated hose 6.1 is externally connected to the cryogenic temperature medium L1 supply system, and is connected to the tool holder through the insulated hose connector external thread 6.1-a, so that the cryogenic medium L1 flow into the CMQL tool holder from the supply system. For tool holder connection frame 6.2, one end of the tool holder connection frame 6.2 is fixed on the outer surface of the heat insulation shell 2.2, and the other end thereof is connected to the machine tool components to keep the external structure of the CMQL tool holder and the machine tool remain stationary. The machine tool spindle head 6.3 is located at the end of the spindle of the machine tool, when the CMQL tool holder is used, it is positioned and installed by the tapered surface 1-d of the toolholder body 1 and the machine tool spindle head 6.3 and pulled by pull nail 6.4; The transportation hose 6.5 is externally connected to the cutting fluid L2 supply system, and is connected to the tool holder through the hose connector external thread 6.5-a, so that the cutting fluid L2 flow into the CMQL tool holder from the supply system. The cryogenic medium L1 and cutting fluid L2 are mixed in the mixing zone 6.6 to become a mixed medium L; the mixed medium L then flow into the hollow internal cooling cutting tool 6.7 installed at the end of the tool holder; The hollow internal cooling tool 6.7 relies on the tapered surface of the elastic collet 6.8 and the tool positioning tapered surface 1-n of the toolholder body 1 for positioning, and then depends on the thread and toolholder external thread II 1-o for clamping installation.

The beneficial effect of the present invention is to solve the problem that the existing external to internal cooling tool holder cannot be used in the CMQL cutting method, and overcome the shortcomings of the existing tool holder in the heat insulation and sealing performance at the same time. In addition to, it extends the application range of the external to internal cooling tool holder to the application field of cryogenic minimum quantity lubrication cutting, and effectively reduces the cutting heat of difficult-to-cut materials in the cutting process, improves the cutting performance of the material, increases the tool life, and replaces the traditional cutting fluid to achieve green manufacturing.

### DESCRIPTION OF THE DRAWINGS

FIG. 1 is an internal cross-sectional view of the tool holder suitable for CMQL.

FIG. 2 is an internal cross-sectional view of the adapter sleeve 2.3.

FIG. 3 is an internal cross-sectional view of the tool holder suitable for CMQL

FIG. 4 is a partial cross-sectional view of the tool holder suitable for CMQL.

FIG. 5 is an enlarged view of the sealing structure II 3.3-b.

FIG. 6 is an assembly drawing of the tool holder suitable for CMQL.

In figure: 1 toolholder body; 1-a internal flow channel I; 1-b internal flow channel II; 1-c toolholder external thread I; 1-d tapered surface; 1-f tool holder internal thread; 1-g flange; 1-h shoulder of stepped shaft; 1-i ring groove I; 1-j toolholder internal shoulder I; 1-k toolholder internal shoulder II; 1-l toolholder internal shoulder III; 1-m ring groove II; 1-n tool positioning tapered surface; 1-o toolholder external thread II; 1-p internal flow channel III; 2.1 metal shell; 2.1-a internal positioning shoulder; 2.2 heat insulation shell; 2.3 adapter sleeve; 2.3-a internal threaded hole I; 2.3-b arc groove I; 2.3-c peripheral sealing tooth I; 2.3-d internal threaded hole II; 2.3-e peripheral sealing tooth II; 2.3-f peripheral sealing tooth III; 2.3-g arc groove II; 3.1 left gland of sealing ring; 3.2 contact sealing ring I; 3.3 sealing structure; 3.3-a sealing structure I; 3.3-b sealing structure II; 3.3-c sealing structure III; 3.4 contact sealing ring II; 3.5 right gland of sealing ring; 3.6 inner sealing ring; 3.7 end face seal; 4.1 toolholder body heat insulation sleeve; 4.2 channel separation sleeve; 4.3 channel heat insulation sleeve; 4.4 heat insulation filler; 5.1 tightening nut; 5.2 bearing I; 5.3 bearing sleeve; 5.4 bearing II; 5.5 bearing gland; 6.1 transportation insulated hose; 6.1-a insulated hose connector external thread; 6.2 tool holder connection frame; 6.3 machine tool spindle head; 6.4 pull nail; 6.5 transportation hose; 6.5-a hose connector external thread; 6.6 mixing zone; 6.7 hollow internal cooling cutting tool; 6.8 elastic collet; L1 cryogenic medium; L2 cutting fluid; L mixed medium.

### DETAILED DESCRIPTION

The specific embodiments of the present invention will be described in detail below with reference to the drawings and technical solutions. In this embodiment, the cryogenic medium L1 is low temperature nitrogen.

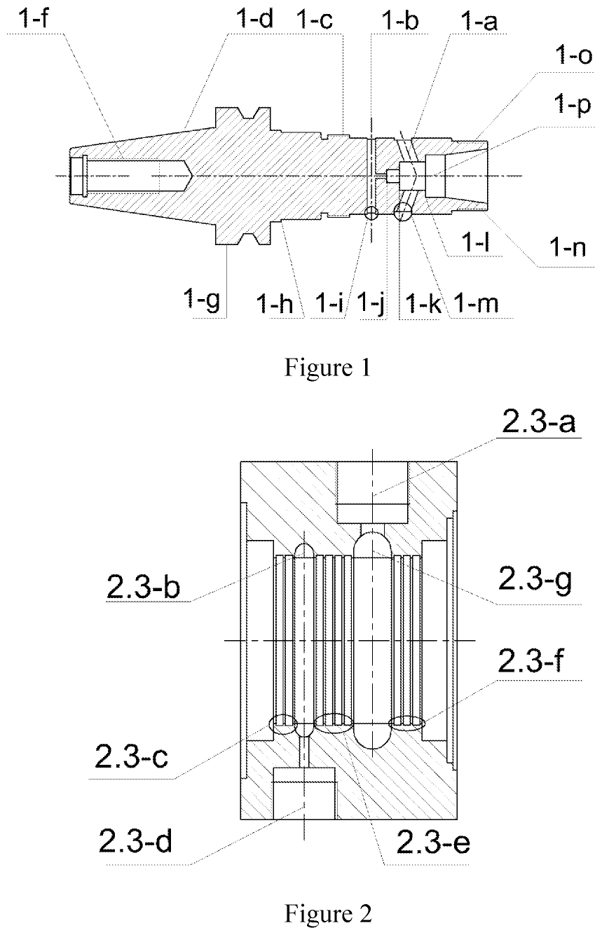

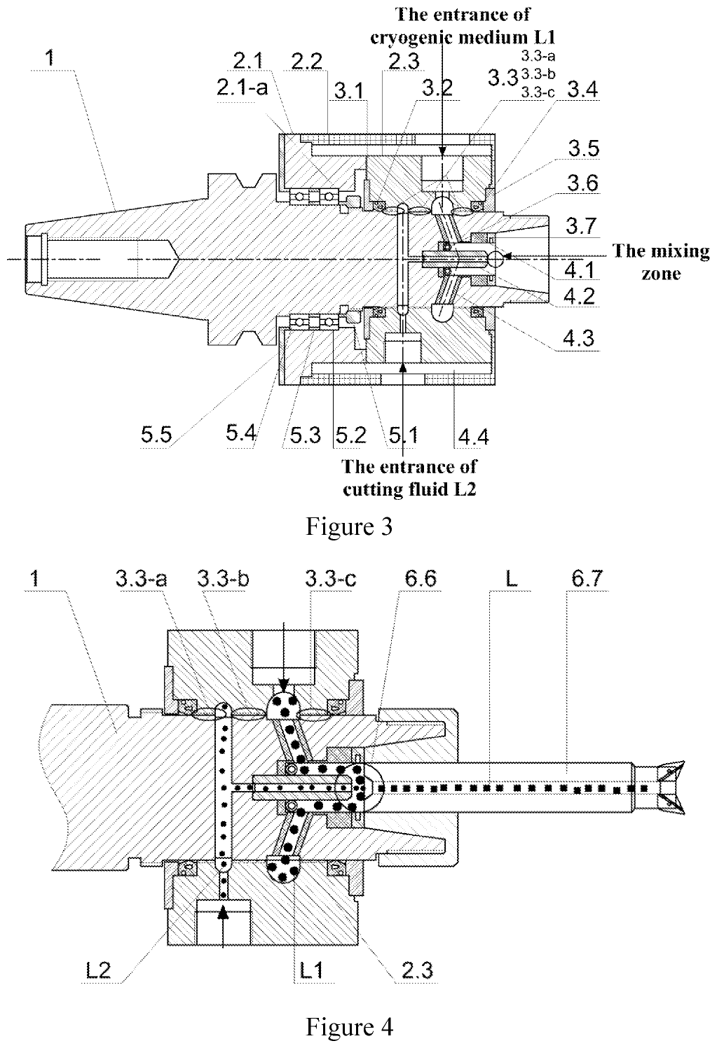

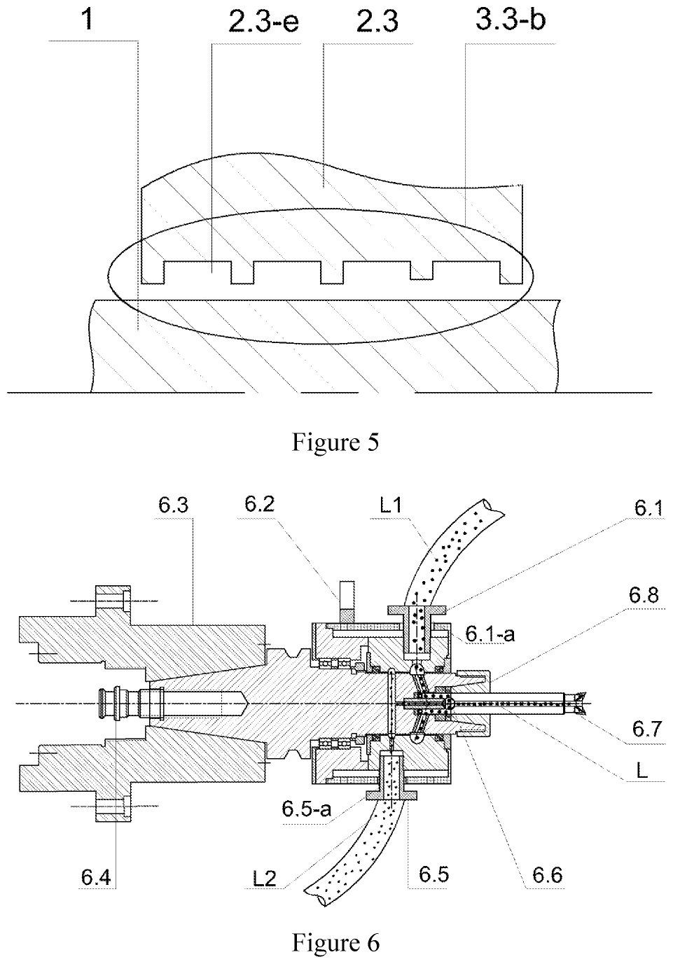

This tool holder suitable for CMQL is improved on the basis of the traditional tool holder structure. As shown in FIG. 1, FIG. 2, FIG. 3, FIG. 4, FIG. 5, FIG. 6, a tool holder suitable for CMQL comprises a tool holder body, a peripheral static structure, a multilayer sealing structure, a thermal insulation structure, and a bearing support structure.

While installing, pushing the channel heat insulation sleeve 4.3 into the internal flow channel I 1-a at low temperature, and positioning the toolholder body heat insulation sleeve 4.1 into toolholder body 1 according to the toolholder internal shoulder III 1-l at low temperature, and then rigging out the end face seal 3.7 with toolholder body heat insulation sleeve 4.1 to complete the installation of the heat insulation seal structure in the internal flow channel I 1-a; Pushing the channel separation sleeve 4.2 according to the position of the toolholder internal shoulder I 1-j into the inside of the toolholder body 1 and the internal flow channel II 1-b to form a complete channel leading to the mixing zone 6.6. And then pushing the internal seal ring 3.6 into the outside of the channel separation sleeve 4.2, positioning the bearing II 5.4 according to the shoulder of stepped shaft 1-h, and then installing the bearing sleeve 5.3 and the bearing I 5.2 in sequence, screwing the tightening nut 5.1 to provide pre-tightening force; screwing into the sealing structure 3.3 and placing the adapter sleeve 2.3 on the outside of the toolholder body 1, and aligning the arc groove I 2.3-b and arc groove II 2.3-g with the ring groove I 1-i and the ring groove II 1-m, and then installing the contact sealing ring I 3.2 on the outside of the adapter sleeve 2.3 and relying on the left gland of sealing ring 3.1 to compress to provide sufficient sealing capacity; positioning and installing the metal shell 2.1 and the bearing I 5.2 and the adapter sleeve 2.3 by the internal positioning shoulder 2.1-a of the metal shell 2.1, and then fixing and pressing the bearing gland 5.5 by screws and the bearing support structure is pressed. Repeating the above operations to completes the installation of contact seal ring II 3.4. And then wrapping the heat insulation filler 4.4 on the outside of the metal shell 2.1, installing the heat insulation shell 2.2 on the outside of the heat insulation filler 4.4, connecting the metal shell 2.1 by bolts to compact the heat insulation filler 4.4. Fixing the tool holder connection frame 6.2 on the circumference of the heat insulation shell 2.2 through bolts to realize the assembly of the entire tool holder.

In order to ensure that the assembled tool holder can meet the performance requirements in actual machining, such as sealing requirements, machining accuracy requirements, etc., it is necessary to ensure the assembly accuracy between components. (1). There is an interference fit between the inner ring of the bearing and the toolholder body 1, and between the contact seal ring and the tool holder, then the coaxially between them is required. (2). The end face that is positioned and in contact with the bearing needs to ensure the verticality requirements. (3). The contact surface of the end face seal 3.7 and the hollow internal cooling cutting tool 6.7 must have flatness requirements to ensure the accuracy of tool positioning. (4). The design of the internal flow channel 1-a of the toolholder body 1. Reasonable design of the inclination angle of the flow channel can reduce the pressure loss of low-temperature nitrogen in the flow channel. (5). The design of labyrinth seal. Reasonably design the labyrinth seal structure, seal structure I 3.3-a, seal structure II 3.3-b, and seal structure III 3.3-c, which can reduce the impact of low temperature nitrogen L1 and cutting fluid L2 leakage on the tool holder structure.

The operation mode of the tool holder device is as follows:

(1) As shown in FIG. 6, when processing, inserting the hollow internal cooling cutting tool 6.7 along the center hole of the elastic collet 6.8, and tightening the elastic collet 6.8 through the external thread of the tool holder to complete the tool installation;

(2) As shown in FIG. 6, installing the tool holder structure equipped with the hollow internal cooling tool 6.7 into the taper hole of the machine tool spindle head 6.3, screwing the pull nail 6.4 into the tool holder internal thread 1-f, and then tightening the tool holder to make the tapered surface 1-d is in close contact with the tapered surface of the machine tool spindle head 6.3 to complete the installation and positioning of the tool holder; fixing the tool holder connection frame 6.2 on the machine tool;

(3) When turning on the spindle motor, the toolholder body 1, toolholder body heat insulation sleeve 4.1, the channel separation sleeve 4.2, the channel heat insulation sleeve 4.3, the inner seal ring 3.6, and the end seal 3.7 and the hollow internal cooling cutting tool 6.7 will rotate and feed with the spindle to realize cutting; a peripheral static structure, a multilayer sealing structure and transportation insulated hose 6.1 and transportation hose 6.5 are kept stationary.

(4) As shown in FIG. 4, the transmission control system of low temperature nitrogen L 1 and the transmission control system of cutting fluid L2 are turned on to automatically transport the medium. The two media flow through the internal flow channel I 1-a and the internal flow channel II 1-b respectively. Mixing is carried out at the mixing zone 6.6, and the mixed medium L flows into the hollow internal cooling cutting tool 6.7, and finally sprayed to the cutting zone to realize cool and lubricate.

It should be noted that the above-mentioned specific embodiments of the present invention are only used to exemplarily illustrate the principle and process of the present invention, and do not constitute a limitation to the present invention. Therefore, any modifications and equivalent replacements made without departing from the spirit and scope of the present invention should be included in the protection scope of the present invention.

1. A tool holder suitable for hybrid cryogenic minimum quantity lubrication, wherein comprising a toolholder body, a peripheral static structure, a multilayer sealing structure, a thermal insulation structure and a bearing support structure;
the left end of toolholder body is a tapered surface, which is used to connected with the machine tool spindle head to position the tool holder; there is an internal thread of the tool holder which is perpendicular to the tapered surface at the end of tapered surface; the extension of the tapered surface is provided with a flange; the right end of the toolholder body are stepped shafts, which are used for the positioning and installation between the toolholder body and the others structures, from the left to the right, there are shoulder of the stepped shaft, toolholder external thread I and toolholder external thread II;
between the toolholder external thread I and the toolholder external thread II, there are ring groove I and ring groove II from left to right; the ring groove I is connected to internal flow channel II the inlet of the internal flow channel II is connected to the ring groove I; the ring groove II is connected internal flow channel I, internal flow channel I is a circular hole flow channel with an inclined angle q to the horizontal plane, the inlet of the internal flow channel I is connected to the ring groove II; internal flow channel I is connected with internal flow channel III which is a horizontal circular channel located at the right end of the inside of the toolholder body; the fluid medium exiting from the internal flow channel III will enter hollow internal cooling cutting tool; there is a toolholder internal shoulder I, a toolholder internal shoulder II and a toolholder internal shoulder III in the toolholder body 1; of which the toolholder internal shoulder I is located at the junction of internal flow channel II and internal flow channel III, the toolholder internal shoulder II and the toolholder internal shoulder III are respectively located on both sides of the internal flow channel I, used for the positioning of tool holder body heat insulation sleeve and channel separator sleeve when they are installed in the toolholder body 1; the inside on the right side of the toolholder body is the tool positioning tapered surface, which is used for the hollow internal cooling cutting tool when installed and positioned through elastic collet and the toolholder body;
the peripheral static structure comprises a metal shell, a heat-insulation shell and an adapter sleeve; the metal shell, which is positioned by internal positioning shoulder of the metal shell and bearing I, is installed on the outside of the internal bearing assembly; the heat-insulation shell is made of materials with low thermal conductivity; the adapter sleeve is made of materials with low thermal conductivity, and it is installed on the outside of the shaft of the toolholder body where the ring groove I and ring groove II are located, adapter sleeve is provided with internal threaded hole I and internal threaded hole II; the internal threaded hole I is used to connect with the insulated hose connector external thread of the external cryogenic medium L1 transportation system, and is the entrance of the cryogenic medium L1; internal threaded hole II, which is the inlet of the cutting fluid L2, is used to connect with the hose connector external thread of the external cutting fluid L2 transportation system; the solidification temperature of the cutting fluid is low; the inner surface of the adapter sleeve is provided with arc groove I and arc groove II, which are respectively connected with the ring groove I and the ring groove II of the toolholder body 1; the cryogenic medium L1 flows in through the internal threaded hole I, is temporarily stored and buffered in the arc groove II, and then flows into the internal flow channel I of the toolholder body 1; at the same time, a small amount of cutting fluid L2 flows in through the internal threaded hole II, and is temporarily stored and buffered in the arc groove I, and then flows into the internal flow channel II of the toolholder body 1; cryogenic medium L1 and cutting fluid L2 form a mixed medium L in mixing zone and enter the hollow internal cooling cutting tool, and finally spray to the cutting zone; the mixing zone is located at the end of the toolholder body 1 where is the exit of the channel separation sleeve; there are peripheral sealing tooth I, peripheral sealing tooth II, peripheral sealing tooth III in the inner surface of the adapter sleeve, they and the corresponding surface of the toolholder body 1 to form a sealing structure I, sealing structure II and sealing structure II respectively; the peripheral sealing tooth I is located on the left side of the arc groove I, and peripheral sealing teeth II is located between arc groove I and arc groove II, and peripheral sealing tooth III is located at right of the arc groove II;
the multilayer sealing structure comprises left gland of the sealing ring, contact sealing ring I, sealing structure, contact sealing ring II, and right gland of sealing ring, inner seal ring in the flow channel and end face seal; the labyrinth sealing structure includes three seal structures, namely seal structure I, seal structure II and seal structure III; the peripheral sealing tooth I of the adapter sleeve and the corresponding shaft surface of the toolholder body 1 are formed the seal structure I to increase the resistance of leakage flow and improve the sealing effect for the cutting fluid L2; the sealing structure II is composed of the peripheral sealing tooth two of the adapter sleeve and the corresponding shaft surface of the toolholder body 1, which is used to increase the flow resistance and increase the sealing effect of cryogenic medium L1 and cutting fluid L2 to prevent the premature mixing of the two media from affecting the effect of CMQL cutting; the sealing structure III comprises the peripheral sealing tooth III of the adapter sleeve and corresponding shaft surface of the toolholder body, which is used to increase the flow resistance and improve the sealing effect to the cryogenic temperature medium L1; the end face seal is located on the right side of the internal flow channel in the toolholder body, and is used to prevent leakage for the cryogenic medium L1 when the hollow internal cooling cutting tool contact with the toolholder body; the left gland of sealing ring and the right gland of sealing ring are respectively distributed on both sides of the adapter sleeve, and are connected with the adapter sleeve by bolts to compress the contact seal ring I and contact seal ring; the contact seal ring I is made of materials with low thermal conductivity and high temperature resistance, which is used to prevent the cutting fluid L2 from leaking into the internal bearing system and ensure the normal operation of the bearing components; the contact seal ring II is also made of materials with low thermal conductivity and high temperature resistance, it is used to prevent the cryogenic medium L1 from leaking into the outside surface of the tool holder causing frost on the surface and affecting the normal operation;
the thermal insulation structure comprises toolholder body heat insulation sleeve, channel separation sleeve, channel heat insulation sleeve, heat insulation filler and heat insulation shell; the heat insulation structure is made of materials with low thermal conductivity; the heat insulation sleeve of the toolholder body is located in front of the mixing zone for reducing the thermal influence of the cryogenic medium L1 on the toolholder body 1; the channel separation sleeve is located in the end of the internal flow channel II and is made of materials with low thermal conductivity to separate the internal flow channel I and the internal flow channel II, to ensure that the fluids do not interfere with each other before entering the mixing zone, and reduce the influence of the cryogenic medium L1 on the cutting fluid L2; the channel heat insulation sleeve is wrapped on the outside of the internal flow channel I of the toolholder body 1 to reduce the low temperature is influence on the toolholder body when the cryogenic medium L1 flows through internal flow channel I; the heat insulation filler is wrapped on the outside of the metal shell; the heat insulation shell is installed on the outside of the thermal insulation filler, and the metal shell is connected by bolts to compress heat insulation filler;
the bearing support structure comprises tightening nut, bearing I, bearing sleeve, bearing II and bearing gland; the bearing II is installed on the shoulder of stepped shaft of the toolholder body; inserting the bearing sleeve and the bearing I in sequence, and then locking the bearing by the tightening nut which can generate pre-tightening force, and realizing the fixing of the bearing support structure on the outer surface of toolholder body 1; bearing I and bearing II are bears with contact seal rings;
the transportation insulated hose is externally connected to the cryogenic temperature medium L1 supply system, and is connected to the tool holder through the insulated hose connector external thread, so that the cryogenic medium L1 flow into the CMQL tool holder from the supply system; for tool holder connection frame, one end of the tool holder connection frame 6.2 is fixed on the outer surface of the heat insulation shell, and the other end thereof is connected to the machine tool components to keep the external structure of the CMQL tool holder and the machine tool remain stationary; the machine tool spindle head is located at the end of the spindle of the machine tool, when the CMQL tool holder is used, it is positioned and installed by the tapered surface of the toolholder body 1 and the machine tool spindle head and pulled by pull nail; the transportation hose is externally connected to the cutting fluid L2 supply system, and is connected to the tool holder through the hose connector external thread, so that the cutting fluid L2 flow into the CMQL tool holder from the supply system; the cryogenic medium L1 and cutting fluid L2 are mixed in the mixing zone to become a mixed medium L; the mixed medium L then flow into the hollow internal cooling cutting tool installed at the end of the tool holder; the hollow internal cooling tool relies on the tapered surface of the elastic collet and the tool positioning tapered surface of the toolholder body 1 for positioning, and then depends on the thread and toolholder external thread II for clamping installation;

2. The tool holder suitable for hybrid cryogenic minimum quantity lubrication according to claim 1, wherein the contact seal ring I and the contact seal ring II are made of materials with low thermal conductivity and high temperature resistance to prevent fluid leakage, to ensure that the tool holder works normally.

3. The tool holder suitable for hybrid cryogenic minimum quantity lubrication according to claim 1, wherein the heat insulation structure is made of materials with low thermal conductivity.
